(19) United States
(12) Patent Application Publication
(10) Pub. No.: US 2006/0062655 A1
(43) Pub. Date: Mar. 23, 2006

(54) Panel lifting and positioning device

(76) Inventor: Ronald E. Harrelson, Lakeland, FL (US)

Correspondence Address: DAVID W. PETTIS, JR., PA, 1210 MILLENIUM PARKWAY, SUITE 2010, BRANDON, FL, 33511-0833, US

(21) Appl. No.: 10/944,215

(22) Filed: Sep. 17, 2004

(51) Int. Cl. B66F 9/18

(52) U.S. Cl. 414/10; 414/11

(57) ABSTRACT

A panel lifting and positioning device for holding, lifting, and positioning sheet material such as, for example, drywall is disclosed. The device is portable, self-powered, and capable of lifting and positioning sheet material at virtually any height and angular orientation through the use of a pressure differential generator on the material-engaging head.

### BACKGROUND OF THE INVENTION

1. Field of the Invention

The present invention relates to a substantially portable, self-contained and self-powered device for lifting and positioning sheet materials used in the construction industry, such as, for example, drywall, and holding the sheet so that it can be installed as required. Using the device of this invention, a single worker can position and install drywall, even in structures having high or sloped ceilings. When used by two or more workers the speed of installation and completion of the project is significantly enhanced.

2. Description of the Prior Art

Within the construction industry, prior art patents disclose and teach a variety of implements for lifting and holding construction materials such as, for example, drywall. While such prior art devices may have proved suitable in years past, today's construction practices frequently call for higher ceilings, plant shelves, and tray ceiling designs. These more modern interior design and construction techniques have significantly increased the costs associated with handling and installing drywall panels and have actually increased the likelihood of injury when workers are struggling to mount such panels overhead, or at an angle with respect to vertical.

In addition, most prior art devices useful for lifting and positioning sheet material require the use of fingers or ledges for holding the sheet material. This frequently results in damage, further increasing the costs of construction. Even if the fingers or ledges do not damage the panel, proper placement of the panel for installation is difficult because of the protruding fingers or ledges.

It is therefore clear that there remains a great need in the art for a device that is capable of lifting, holding and positioning sheet material at virtually any angle between 0 and 180 degrees, wherein such device may be safely operated by one worker within the confines of an interior space. Inasmuch as such devices are typically used before permanent power has been supplied to the space, such a device should be self-powered, and, of course, must be readily movable. As with virtually any article of manufacture, portability from job site to job site is also a desirable asset.

### SUMMARY OF THE INVENTION

The present invention relates to a lifting and positioning device primarily intended for use with sheet materials used in the construction industry. The device comprises a base, a lift section attached to the base, a boom attached to the top of the lift, a material-engaging head attached to the boom, and a pressure differential generator attached to the material-engaging head whereby the panel may be held thereon for positioning. According to a preferred embodiment, described in detail below, the device further comprises electrically operated control means whereby the worker may raise and lower the lift, raise and lower the boom, articulate the material-engaging head, and actuate the pressure differential generator to hold a panel thereagainst. According to this preferred construction, the control means is powered by one or more batteries mounted on the base.

The invention accordingly comprises the features of construction, combination of elements, and arrangement of parts which will be exemplified in the construction hereinafter set forth, and the scope of the invention will be indicated in the claims.

### BRIEF DESCRIPTION OF THE DRAWINGS

For a fuller understanding of the nature and objects of the invention, reference should be had to the following detailed description taken in connection with the accompanying drawings, in which:

FIG. 1 is a side elevation, partially fragmentary, of a preferred embodiment of this invention with the lift raised.

FIG. 2 is a rear elevation of the preferred embodiment shown in FIG. 1.

FIG. 3 is a top plan detail of the lift motor.

FIG. 4 is a side elevation, partially fragmentary, of the lift motor of FIG. 3.

FIG. 5 is a side elevation of the base.

FIG. 6 is a rear elevation of the base shown in FIG. 5.

FIG. 7 is a partial side elevation of the boom and material-engaging head, showing movement in phantom.

FIG. 8 is a detail, partially fragmentary, of the boom motor.

FIG. 9 is a side elevation similar to that of FIG. 1 with the lift lowered.

FIG. 10 is a back side elevation of the material-engaging head showing support arms on each side thereof.

FIG. 11 is a detail side elevation of the material-engaging head, partially in section.

FIG. 12 is a detail view of a material-engaging head support arm.

FIG. 13 is a schematic of the control means electrical circuit.

Similar reference characters refer to similar parts throughout the several views of the drawings.

### DETAILED DESCRIPTION

Before proceeding to a detailed description of the preferred embodiment for the lifting and positioning device of this invention, generally indicated as 20 in the drawing figures, it is to be emphasized that this is merely a preferred embodiment. Numerous changes and modifications are contemplated, as set forth below, and are intended to fall within the scope of the present invention. For example, the lift, generally indicated as 22, and the boom, generally indicated as 24, are both illustrated as being of a scissor-jack construction. Equivalent substitutes might include, for example, pneumatic or hydraulic rams, or pulley and cable assemblies. In like fashion, while the lift motor 26, the boom motor 28, and the material-engaging head motor 30 in this preferred embodiment are electric screw-thread drives, rams, cables and pulleys, or even eccentric levers may be substituted.

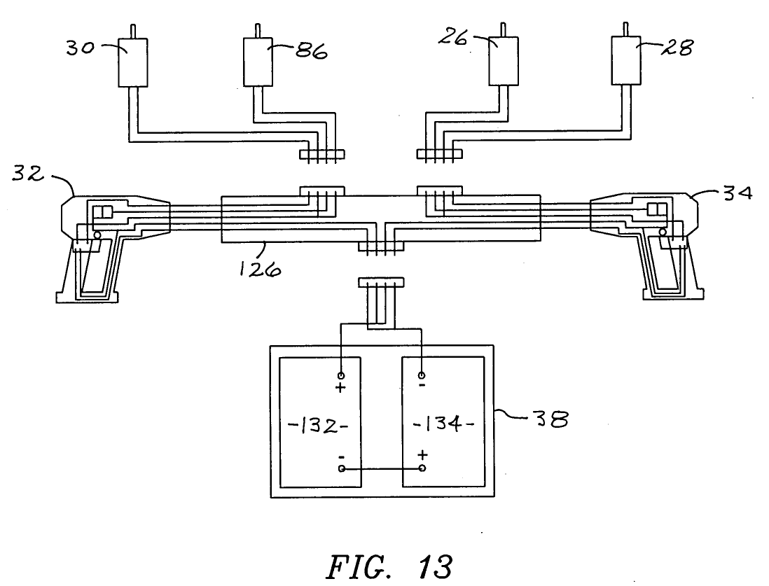

As will become evident in the following detailed description, left controller 32 and right controller 34 of this preferred embodiment are actually modified power drill housings and circuitry. Other switch devices may be utilized in accord with the example circuit of FIG. 13 and are intended to be encompassed within the scope of the present invention. Furthermore, primarily for purposes of convenience and portability, this preferred embodiment for device 20 derives its power from a pair of 12 volt batteries 132 and 134 housed within battery box 38. Clearly, the present invention could be constructed to operate on alternating current by modifying the circuitry and providing a receptacle for the source of such power. In fact, though believed to be somewhat cumbersome, the present invention could be modified for mechanical, pneumatic, or hydraulic operation.

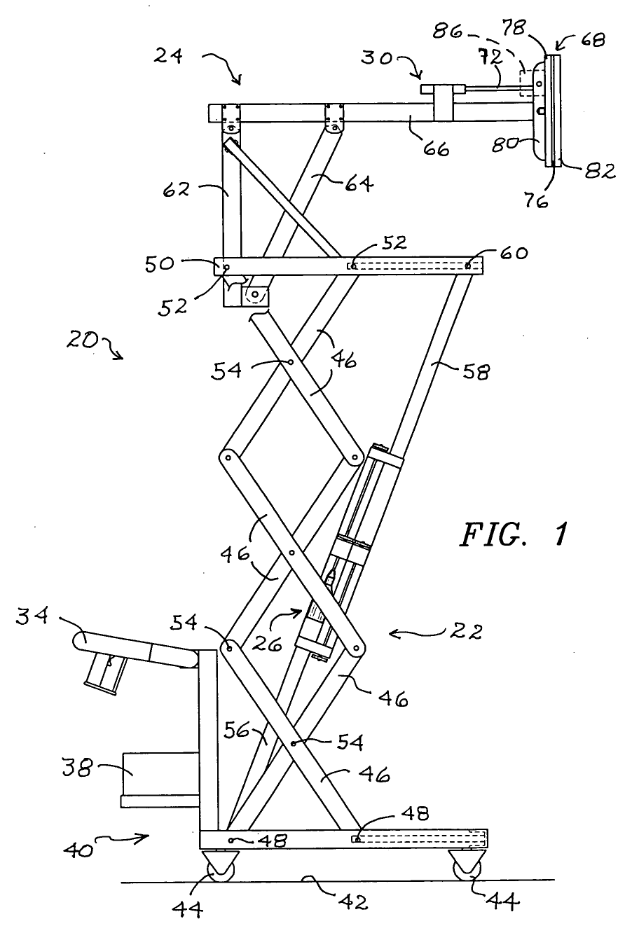

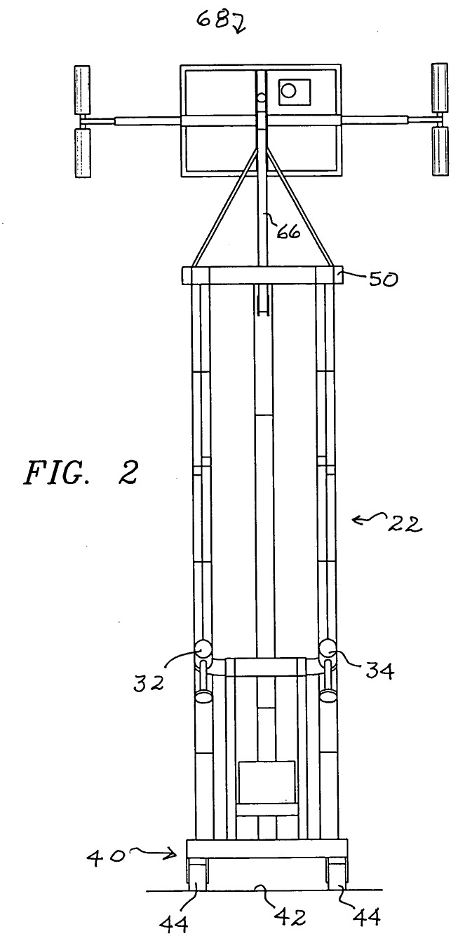

Referring to the drawing figures, FIG. 1 illustrates a preferred embodiment for device 20. As shown therein, device 20 includes a base, generally indicated as 40, for supporting device 20 on a support surface 42, and movement across support surface 42 may be accomplished manually with rollers or wheels 44.

Lift 22 is mounted on the base 40 and, as shown in the drawing figures, comprises a standard scissor construction in this preferred embodiment of device 20. The up and down motion of lift 22 is accomplished by lift motor 26, more fully described below. The lift 22 actually comprises a plurality of lift links 46, two of which are pivotally attached to base 40 at base pivot points 48, two of which are attached to base upper frame 50 at base upper frame pivot points 52, with the remaining scissor pivots indicated at 54. For up and down operation, lift motor 26 comprises lift motor lower arm 56, a distal end of which is pivotally attached at base pivot point 48, and lift motor upper arm 58, a distal end of which is pivotally attached to base upper frame 50 at lift motor upper arm pivot 60.

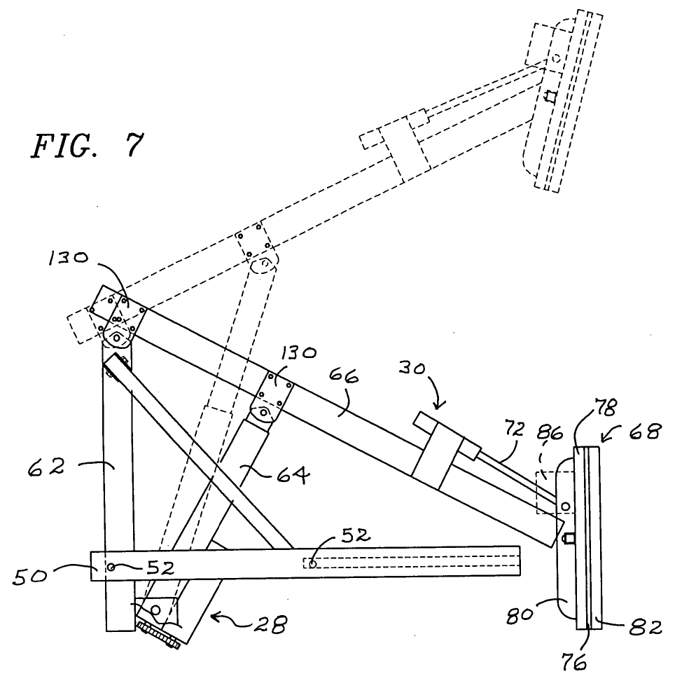

A fixed boom support 62 extends upwardly from base upper frame 50, and a pivoting and extendable boom link 64 is provided for raising and lowering boom 24. As best seen in the view of FIG. 7, boom motor 28 is mounted on pivoting and extendable boom link 64 whereby boom 24 may be raised and lowered as indicated in phantom in the view of FIG. 7.

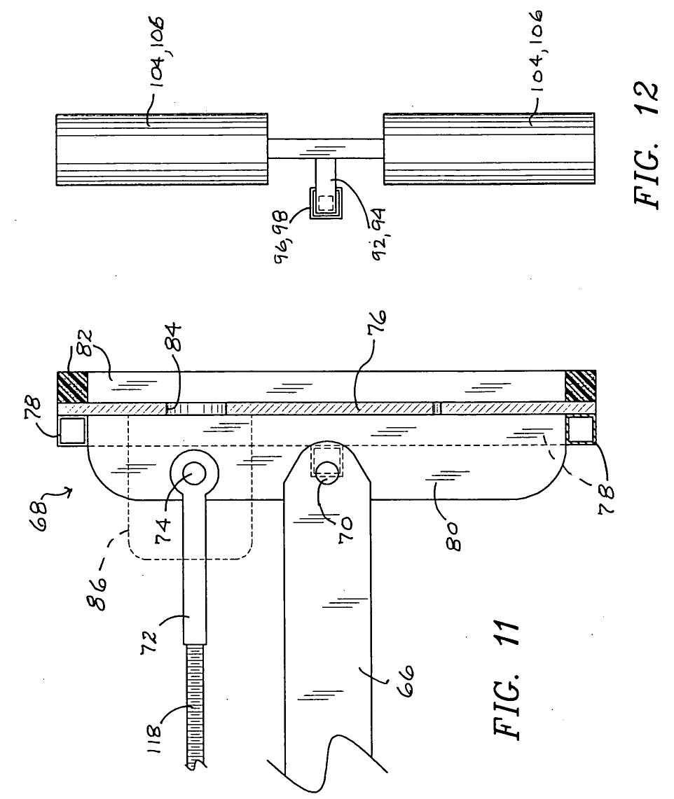

Pivotally mounted at the distal end of boom arm 66 is the material-engaging head, generally indicated as 68. Articulation of material-engaging head 68 is accomplished by the action of material-engaging head motor 30. Referring to the view of FIG. 11, the pivoting attachment between boom arm 66 and material-engaging head 68 is indicated at head pivot 70. FIG. 11 further illustrates the pivoting attachment of head motor rod 72 to material-engaging head 68 at head motor pivot 74.

Referring to the views of FIGS. 10 and 11, material-engaging head 68 is formed from a sheet of substantially non-porous material 76 and is bounded by head frame 78. A head channel 80 is provided on the back surface of sheet 76 for attachment of the distal end of the boom arm 66 and of head motor rod 72. Extending outwardly from the front surface of sheet 76 and around its perimeter is a gasket 82. An aperture 84 is formed through sheet 76 and, as indicated in phantom in the view of FIG. 11, a pressure differential generator is operatively mounted on the back side of sheet 76 in surrounding relation to aperture 84. Actuation of pressure differential generator 86, which in this embodiment is a direct current vacuum motor, will draw air inwardly through aperture 84. Clearly, then, if a sheet of material such as, for example, drywall is disposed in overlying relation to gasket 82, a pressure differential will be created within the void defined by the material, gasket 82, and the front surface of sheet 76, thereby holding and retaining the material on material-engaging head 68.

The views of FIGS. 10 and 12 provide further details with regard to left support arm and right support arm, generally indicated as 88 and 90, respectively. The support arms 88 and 90 are removably and adjustably attachable to material-engaging head 68 as by inserting their respective support rods, 92 and 94, into corresponding receiver tubes 96 and 98. Support rods 92 and 94 are held in position by respective pins 100 and 102, and the distance that the rods 92 and 94 extend outwardly from material-engaging head 68 is adjustable, independently. In fixed and substantially transverse relation to the distal end of each of the support rods 92 and 94 are corresponding padded arms 104 and 106. Use of support arms 88 and 90, though not required, will increase the stability of a sheet of material being lifted and positioned by device 20.

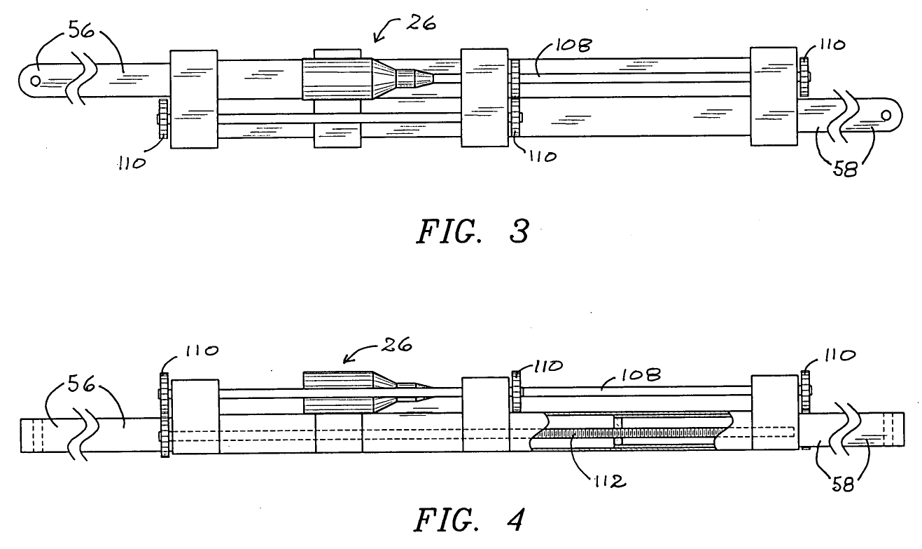

Turning to the views of FIGS. 3 and 4, it can be seen that in this preferred embodiment for device 20 lift motor 26 will rotate lift rod 108, and that rotary motion is translated through lift gears or sprockets 110 to result in forward or backward motion (depending upon the direction of rotation of lift rod 108) to selectively extend or retract lift motor upper arm 58 by its engagement with lift thread rod 112.

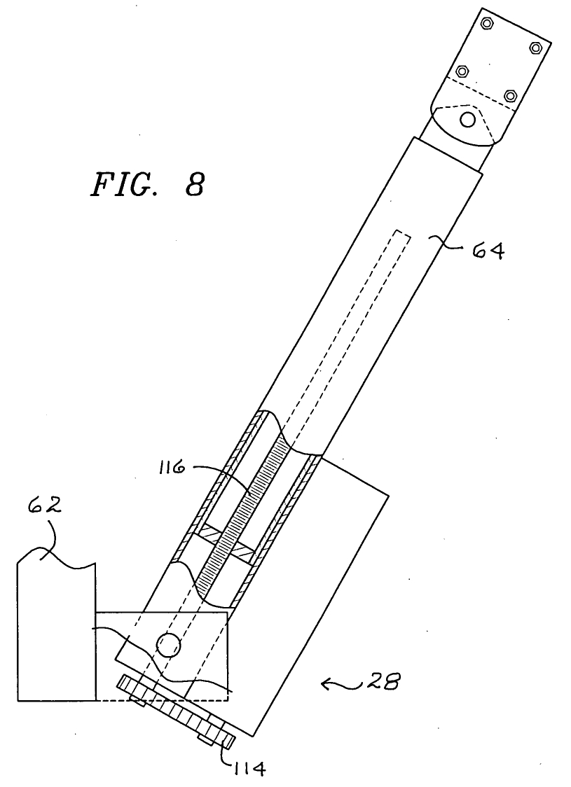

As shown in the view of FIG. 8, the preferred construction and operation of boom motor 28 is substantially the same as that of lift motor 26. Rotary motion of boom motor 28 is transferred through boom gears or sprockets 114 to boom thread rod 116, and this results in corresponding extension or retraction (depending upon the direction of rotation) of pivoting and extendable boom link 64.

In like fashion, material-engaging head motor 30 causes rotation of head thread rod 118, best seen in the view of FIG. 11, to articulate material-engaging head 68.

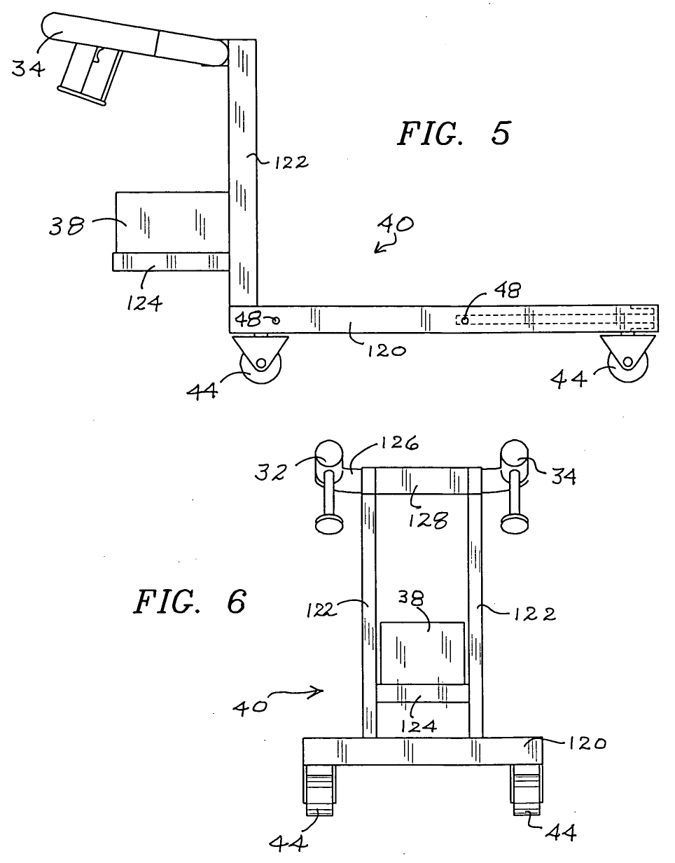

Turning to the views of FIGS. 5 and 6, further details of the base 40 may be seen. Base 40 includes a bottom frame 120 and a pair of vertical control frames 122 extending upwardly therefrom. A battery support 124 is provided between the vertical control frames 122, and left and right controllers 32 are removably attachable to the top of vertical control frames 122 by controller mounting bar 126. A top frame connector 128 extends transversely between and is attached to the distal end of each of the vertical control frames 122 for stability. Controller mounting bar 126 and left and right controllers 32 and 34 attached thereto are removably attachable to base 40 to facilitate the transport of device 20 from one site to another. According to this preferred construction, boom arm 66 is also removably attachable to device 20 at boom arm brackets 130, best seen in the view of FIG. 7. Battery box 38 may also be removed from battery support 124.

Turning to the schematic view of FIG. 13, one can see that battery box 38, according to this preferred embodiment, contains left battery 132 and right battery 134. A standard, pin-type connector is provided for the removal of batteries 132 and 134 from device 20, and the schematic of FIG. 13 further illustrates similar pin-type connections for the removal of controller mounting bar 126. In this preferred embodiment for device 20, lift motor 26 and boom motor 28 are 24 volt D.C. motors, and material-engaging head motor 30 and pressure differential generator 86 are 12 volt, D.C., motors. Of course, this arrangement is not to be interpreted as limiting the scope of the present invention. As indicated above, different motor sizes could be used, and alternating current could be used. In addition, lift motor 26 is preferably selected as a two-speed motor, but that also is not to be considered as limiting the scope of the present invention.

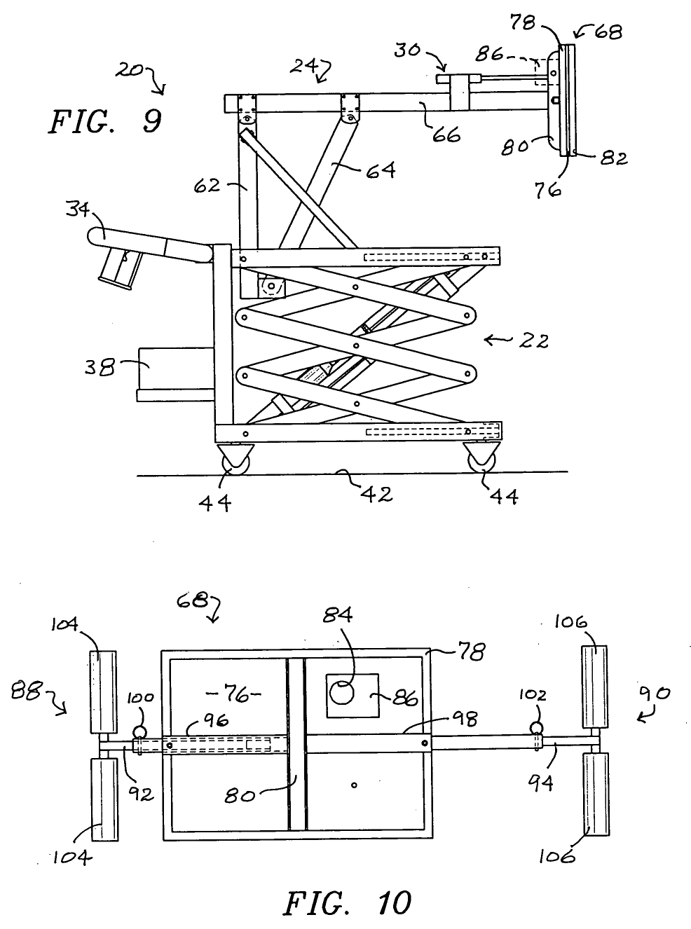

All structural elements of this preferred embodiment are preferably formed from aluminum for purposes of weight reduction and strength. Because of the construction of device 20 whereby boom 24, controller mounting bar 126, and battery box 38 may be removed, transportation of device 20 in, for example, a standard utility van, is provided. When those elements are removed, the base 40 and lift 22 may be lifted by two persons with relative ease for placement in a transporting vehicle. According to this preferred embodiment, in its fully extended position, as illustrated in the view of FIG. 1, a construction panel may be placed slightly more than fifteen feet above the supporting surface. In the fully lowered position shown in the view of FIG. 9, the height of device 20 from the support surface is slightly less than four feet. Testing of this device has confirmed that the pressure differential generator 86 will successfully and safely lift and hold a four by eight, one half inch, sheet of drywall weighing approximately forty-six pounds; a four by twelve, five eighths inch, sheet of drywall weighing approximately one hundred thirteen pounds; a four by eight sheet of hardy board; and a four by eight sheet of plywood. In fact, testing has demonstrated that when device 20 is used to lift drywall from a stack of drywall sheets, care must be taken so that only one sheet is lifted. Because of the drywall's porosity, lifting of two four by eight sheets, simultaneously, can occur.

It will thus be seen that the objects set forth above, among those made apparent from the preceding description, are efficiently attained, and since certain changes may be made in the above construction without departing from the scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between.

Now that the invention has been described,

What is claimed is:

1. A lifting and positioning device primarily intended for use with sheet material used in the construction industry, said device comprising: a base for supporting said device on a surface; a lift attached to said base; a boom attached to said lift; a material-engaging head attached to said boom; and a pressure differential generator attached to said material-engaging head; said device further comprising control means operatively mounted thereon whereby said lift may be raised and lowered, said boom may be raised and lowered, said material-engaging head may be articulated, and said pressure differential generator may be actuated to hold the material.

2. A lifting and positioning device as in claim 1 wherein said control means comprises at least one controller mounted on said base and a lift motor operatively connected to said at least one controller and to said lift, whereby said lift may be raised and lowered.

3. A lifting and positioning device as in claim 2 wherein said lift motor is electric.

4. A lifting and positioning device as in claim 1 wherein said control means comprises at least one controller mounted on said base and a boom motor operatively connected to said at least one controller and to said boom, whereby said boom may be raised and lowered.

5. A lifting and positioning device as in claim 4 wherein said boom motor is electric.

6. A lifting and positioning device as in claim 1 wherein said control means comprises at least one controller mounted on said base and a material-engaging head motor operatively connected to said at least one controller and to said material-engaging head, whereby said material-engaging head may be articulated.

7. A lifting and positioning device as in claim 6 wherein said material-engaging motor is electric.

8. A lifting and positioning device as in claim 1 wherein said control means comprises at least one controller mounted on said base and operatively connected to said pressure differential generator, whereby said pressure differential generator may be actuated to hold the material.

9. A lifting and positioning device as in claim 8 wherein said pressure differential generator is electric.

10. A lifting and positioning device as in claim 1 further comprising a power source mounted on said base, said power source being operatively connected to said control means.

11. A lifting and positioning device as in claim 1 wherein said material-engaging head comprises a panel of substantially non-porous material, said panel having a front side, a back side, and a perimeter edge, said panel being pivotally attached to said boom and further comprising an aperture formed through said front side and said back side in spaced apart relation to said perimeter edge and a gasket disposed on said panel front side around said perimeter edge, said pressure differential generator being attached to said panel back side in operative, surrounding relation to said aperture, whereby actuation of said pressure differential generator will cause the material placed against said gasket to be held on said material-engaging head.
